(19) United States
(12) Patent Application Publication
(10) Pub. No.: US 2011/0134477 A1
(43) Pub. Date: Jun. 9, 2011

(54) Network Printer

(75) Inventors: Tetsuya Kuwahara, Kyoto-shi (JP); Akinori Nishizawa, Kyoto-shi (JP)

(73) Assignee: Muratec Machinery Ltd., Kyoto (JP)

(21) Appl. No.: 12/965,759

(22) Filed: Dec. 10, 2010

(30) Foreign Application Priority Data
Dec. 9, 2009 (JP) 2009-279828

(51) Int. Cl. G06F 3/12

(52) U.S. Cl. 358/1.15

(57) ABSTRACT

A network printer includes a communication unit that conducts communication with a communication terminal connected through a network, and a recording unit. The recording unit can be put in a first power state and a second power state, whose power consumption is lower than that of the first power state, and the recording unit records print data received from the communication unit during the first power state. The communication unit includes a confirmation signal delivery unit that sends a connection confirmation signal to the communication terminal when the print data is not successively received from the communication terminal for a first predetermined time while a session is established and a transition unit that causes the power state of the recording unit to transition to the second power state when a reply to the connection confirmation signal has not been successively received for a second predetermined time.

### CROSS-REFERENCE TO RELATED APPLICATIONS

This application claims priority under 35 U.S.C. 119 to Japanese Patent Application No. 2009-279828, filed on Dec. 9, 2009, which application is hereby incorporated by reference in its entirety.

### BACKGROUND OF THE INVENTION

1. Field of the Invention

The present invention relates to a network printer and, particularly to a network printer that can be put in a low-power consumption state.

2. Description of the Related Art

Recently, from a viewpoint of CO₂ emission reduction, there is a social demand for low power consumption of an electric instrument. For example, in a network printer that is used while connected to a network such as a LAN, there is known a network printer that achieves power saving of the device by a transition to the low-power consumption state (energy-saving state) in which power supplies to a printer controller, a printer engine, and the like are stopped during a standby state.

In such network printers, when print data is being received from a communication terminal such as a personal computer, for example, sometimes an abnormal network environment or communication terminal is generated, and the print data cannot be received in midstream. In such cases, the conventional network printer usually maintains at a reception state until a constant time (for example, five minutes) elapses. When the print data has not been successively received for five minutes or more, the network printer ends processing of receiving the print data, and transitions to the low-power consumption state.

As described above, for the configuration in which the reception state is maintained until a constant time elapses, supplies of power to a printer controller and a printer engine cannot be stopped in the meantime. Therefore, the network printer cannot lively transition to the low-power consumption state. On the other hand, if the time to maintain the reception state is simply shortened in the conventional network printer, in the case where output of the print data is tentatively stopped due to, e.g., an increased processing load on a communication terminal, possibly the reception processing is ended on the network printer side until the output from the communication terminal is restored.

### SUMMARY OF THE INVENTION

The present invention has been made to overcome the problems described above. An object of the present invention is to provide a network printer that can transition properly and rapidly to a low-power consumption state when print data is not received by the network printer that can be put in the low-power consumption state.

A network printer according to the present invention includes a communication unit that conducts communication with a communication terminal connected through a network, and a recording unit that can be put in a first power state and a second power state, the power consumption of the second power state being lower than that of the first power state. The recording unit records print data received from the communication unit onto a sheet when being in the first power state. The communication unit includes a confirmation signal delivery unit that sends a connection confirmation signal to the communication terminal when the print data is not successively received from the communication terminal for a first predetermined time while a session is established. The inventive network printer also includes a transition unit that causes the power state of the recording unit to transition to the second power state when a reply to the connection confirmation signal is not successively received for a second predetermined time after the confirmation signal delivery unit sends the connection confirmation signal.

An abnormal network due to drop-out of a connector of a LAN cable or disconnection and tentative stop of print data output due to an increased processing load on a communication terminal can be cited as an example for the cause of the communication interruption. When the communication interruption is caused by the abnormal network, the possibility of automatically restoring the network connection in a short time is low, and a reply will likely not be received even if the connection confirmation signal is sent. On the other hand, when the communication interruption is caused by, e.g., the processing load on the communication terminal, the possibility of automatically restoring the network connection in a relatively short time is high, and the reply to the connection confirmation signal will likely be received.

According to the network printer of the present invention, the connection confirmation signal is sent to the communication terminal when the print data is not successively received from the communication terminal for the first predetermined time. When the reply to the connection confirmation signal has not been successively received for the second predetermined time after the connection confirmation signal is sent, the recording unit transitions to the second power state (low-power consumption state), whose power consumption is lower than that of the first power state. In this case, for example, when the first predetermined time is set to about 3 seconds while the second predetermined time is set to about 5 seconds, the connection confirmation signal is sent in early timing after the communication interruption is generated, and the presence or absence of the reply to the connection confirmation signal is detected to rapidly make the determination whether the possibility of automatically restoring the interruption of the print data in a short time is high or low. When the reply cannot be received, that is, when the determination is made that the possibility of automatically restoring from the interruption of the print data in a short time is low due to the abnormal network, the recording unit can transition rapidly to the low-power consumption state without awaiting the reply longer. Therefore, when the print data is received, the recording unit can transition properly and rapidly to the low-power consumption state in response to the communication interruption.

More specifically, preferably the recording unit includes a printer controller that expands the print data described in a page description language into raster data, a printer engine that records the raster data onto the sheet, and a control unit that controls the printer engine. The communication unit aborts processing of conducting communication with the communication terminal and the transition unit causes the respective power state of the printer controller, the printer engine, and the control unit to transition to the second power state, when a reply to the connection confirmation signal is not successively received for the second predetermined time.

In the network printer according to the present invention, preferably the communication unit includes a PHY unit that performs conversion between a logic signal and an electric signal, and the confirmation signal delivery unit sends the connection confirmation signal when the PHY unit is in a link-up state.

In the network printer according to the present invention, preferably a session with the communication terminal is released and the transition unit causes the power state of the recording unit to transition to the second power state, when the PHY unit is not in the link-up state.

In this case, the connection confirmation signal is sent, when the PHY unit of the communication unit is in the link-up state, that is, when the network connection to the closest hub or router is physically normal. In the network printer of the present invention, when linkdown of the PHY unit is generated, that is, when the abnormal network connection to the closest hub or router is generated, the connection confirmation signal is not sent after the first predetermined time, and the recording unit does not transition to the low-power consumption state after the second predetermined time. Therefore, in the network printer according to the present invention, the recording unit can immediately transition to the low-power consumption state at the time the linkdown is generated.

In the network printer according to the present invention, preferably the confirmation signal delivery unit sends the connection confirmation signal to the communication terminal, when a reply to the connection confirmation signal is received before the second predetermined time elapses since the connection confirmation signal is sent, and when the print data has not successively been received for a time longer than the first predetermined time.

When the reply to the connection confirmation signal is received, for example, it is presumed that the sending of the print data is tentatively stopped due to the increased processing load on the communication terminal side while the network is normally connected. In such cases, the possibility of repeatedly generating a similar state is high. However, in this case, when the connection confirmation signal is frequently sent, the processing load on the communication terminal is further increased. That is, reception processing, processing of analyzing the received data, and processing of transmitting reply data are increased. On the other hand, according to the network printer of the present invention, when the reply to the connection confirmation signal is received at once, that is, when the network is normally connected, the connection confirmation signal is sent while a time interval is lengthened during the communication interruption from the second time. Therefore, the increase of the unnecessary processing load on the communication terminal can be reduced.

In the network printer according to the present invention, preferably the connection confirmation signal is an ARP or a ping. Therefore, the abnormal connection to the communication terminal, that is, abnormal network can be detected without use of the dedicated communication protocol, so that versatility can be enhanced.

In the network printer according to the present invention, preferably the communication unit notifies the printer controller of information indicating an end of reception when processing of receiving the print data transmitted from the communication terminal is normally ended. The printer controller notifies the control unit of information indicating an end of the expanding processing and transitions to the second power state when the expansion of the print data is ended. And the control unit notifies the communication unit of information indicating an end of the recording processing and transitions to the second power state when the printer engine ends the recording of the print data.

Therefore, when the reception of the print data is normally ended, the printer controller and the control unit can sequentially transition to the second power state (low-power consumption state), whose power consumption is lower than that of the first power state.

In the network printer according to the present invention, preferably the communication unit further includes a temperature control unit that performs temperature control such that a temperature at the recording unit becomes a predetermined temperature or lower after the power state of the recording unit transitions to the second power state.

Generally, in the network printer, the temperature at the printer engine is lowered after the print data is recorded, and the transition is made to the second power state (low-power consumption state), whose power consumption is lower than that of the first power state. When the control unit performs the temperature control during the transition to the low-power consumption state, the control unit cannot transition to the low-power consumption state until the temperature at the printer engine is lowered. On the other hand, because it is necessary for the communication unit to be always in the reception state, the communication unit does not become the low-power consumption state. At this point, according to the network printer of the present invention, the communication unit performs the temperature control such that the temperature at the recording unit becomes the predetermined temperature or lower. Therefore, the control unit can transition rapidly to the low-power consumption state.

In the network printer according to the present invention, preferably, when the communication unit receives the print data from the communication terminal, after a session is established with the communication terminal, a session establishment request received from the communication terminal is analyzed and an IP address or a MAC address of the communication terminal is extracted.

According to the present invention, in the network printer that can be put in the low-power consumption state, the network printer can properly and rapidly transition to the low-power consumption state when the print data is not received.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating an entire configuration of a network multifunction peripheral on which a network printer according to an embodiment of the present invention is mounted; and

FIG. 2 is a flowchart illustrating a processing procedure of a low-power consumption state transition processing performed by the network multifunction peripheral.

### DETAILED DESCRIPTION OF PREFERRED EMBODIMENT

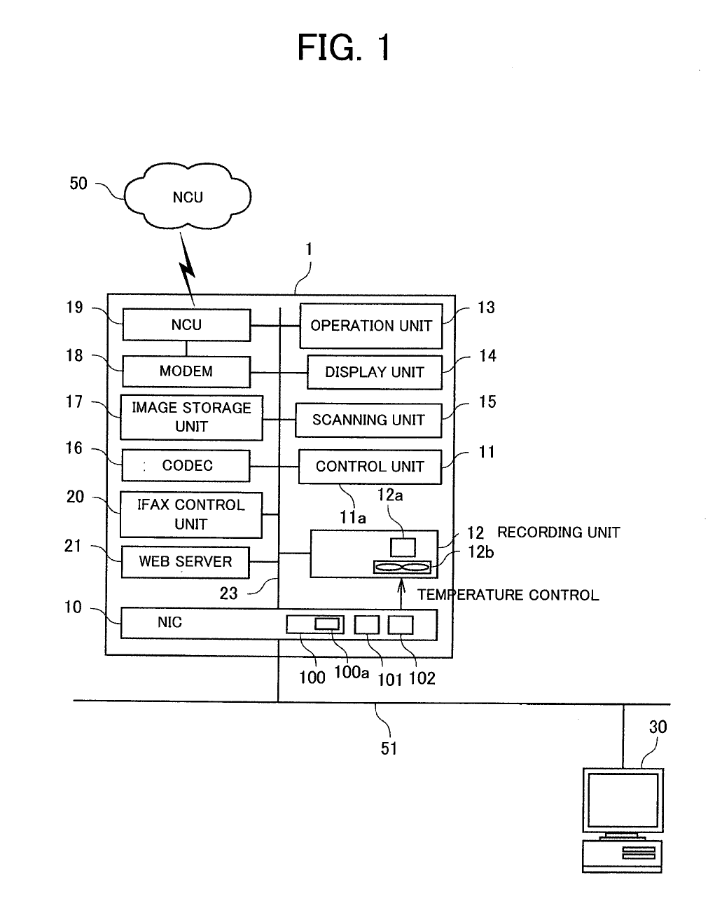

Hereinafter, a preferred embodiment of the present invention will be described in detail with reference to the drawings. Throughout the drawings, like components are designated by like reference symbols, and the overlapping description is not given. The case where a network printer according to an embodiment of the present invention is applied to a network multifunction peripheral (MFP) is described by way of example. A network system in which the network multifunction peripheral is connected to a personal computer (hereinafter referred to as a “PC”) through a LAN is described by way of example. A configuration of the exemplary network system is simplified for the sake of easy understanding. An entire configuration of a network multifunction peripheral 1 will be described with reference to FIG. 1. FIG. 1 is a block diagram illustrating the entire configuration of the network multifunction peripheral 1 connected to a LAN 51.

The network multifunction peripheral 1 is one that can be put in a low-power consumption state (energy-saving state) during a standby state. The network multifunction peripheral 1 includes a scanner function of scanning a document to produce image data, a copy function of recording the produced image data onto a sheet, a FAX receiving function of recording the image data received through facsimile communication onto the sheet, and a PC print function of recording onto the sheet print data received from a PC 30 connected through a LAN 51. The network multifunction peripheral 1 also includes a FAX transmitting function of facsimile-transmitting the scanned image data and a PC-FAX function of facsimile-transmitting the image data received from the external PC 30 and the like. The network multifunction peripheral 1 also has an Internet FAX (IFAX) function of transmitting and receiving the image data through an IP network by utilizing an electronic mail. In order to realize each function, the network multifunction peripheral 1 includes an NIC 10, a control unit 11, a recording unit 12, an operation unit 13, a display unit 14, a scanning unit 15, a codec 16, an image storage unit 17, a modem 18, a NCU 19, an IFAX control unit 20, and a Web server 21. The units are connected through a bus (communication path) 23 to enable communication with one another.

The NIC 10 is a network interface that performs processing of controlling transmission and reception of various communication protocols, processing of analyzing data on various communication protocols, and processing of producing data. For example, according to TCP/IP, the NIC 10 is connected to the PC 30 through the LAN 51, and the NIC 10 conducts data communication with the PC 30. A power is supplied to the NIC 10 even in the standby state, that is, when the network multifunction peripheral 1 is in the low-power consumption state.

The NIC 10 includes a microprocessor that performs a computation, a ROM in which a program is stored in order to cause the microprocessor to perform each piece of processing, a communication chip (IC) that performs communication processing under the microprocessor, a RAM in which received data received by the communication chip and read from the communication chip is tentatively stored, and a backup RAM in which data is backed up. The NIC 10 may be formed using a microcomputer in which the microprocessor, the communication chip, the ROM, and the RAM are integrated into one chip.

In the NIC 10, a transmission and reception unit 100, a transition signal output unit 101, and a temperature control unit 102 are constructed using a combination of the above-described hardware and software.

The transmission and reception unit 100 receives a network packet (such as print data) from the PC 30 through the LAN 51. When the print data is not successively received from the PC 30 for a first predetermined time (for example, 3 seconds), the transmission and reception unit 100 sends an ARP (Address Resolution Protocol) to ask a MAC address or a ping to confirm the communication through the network to the PC 30 while a session is established with the PC 30. More specifically, the transmission and reception unit 100 includes a PHY (PHYsical Layer) unit 100a that performs conversion between a logic signal and an electric signal. When the PHY unit 100a is in a link-up state, that is, when the network connection to the closest hub or router (not illustrated) is physically normal, the transmission and reception unit 100 sends a connection confirmation signal.

When a reply to the connection confirmation signal has not been successively received for a second predetermined time (for example, 5 seconds) after the connection confirmation signal is sent, the transmission and reception unit 100 releases the session with the PC 30 to end the print data receiving processing. On the other hand, when the reply to the connection confirmation signal is received before the second predetermined time elapses since the connection confirmation signal is sent, and when the print data is not successively received for a time longer than the first predetermined time, the transmission and reception unit 100 sends the connection confirmation signal to the PC 30. When the processing of receiving the print data transmitted from the PC 30 is normally ended, the NIC 10 notifies a printer controller 11a (described in detail later) constituting the control unit 11 of information indicating the end of the reception.

When the reply to the connection confirmation signal has not been successively received for the second predetermined time after the transmission and reception unit 100 sends the connection confirmation signal, the transition signal output unit 101 outputs a transition signal in order to cause the control unit 11 and the recording unit 12 to transition from a normal power state to a low-power consumption state. When the transition signal output unit 101 outputs the transition signal to the control unit 11 and the recording unit 12 or a power control unit that controls the supply of the power, the supplies of the power to the control unit 11 and the recording unit 12 are stopped to cause the control unit 11 and the recording unit 12 to transition to the low-power consumption state.

After the recording unit 12 transitions to the low-power consumption state, the temperature control unit 102 performs temperature control (fan control) such that a temperature at the recording unit 12 (in particular, a printer engine 12a to be described in detail later) is lowered to a predetermined target temperature. More specifically, a cooling fan 12b provided in the recording unit 12 is driven to lower the temperature at the recording unit 12 (printer engine 12a) to the target temperature.

The control unit 11 includes a microprocessor that performs a computation, a ROM in which a program is stored in order to cause the microprocessor to perform each act of processing, a RAM in which various kinds of data such as a computation result are tentatively stored, and a backup RAM in which backup data is stored. The control unit 11 executes the stored program, thereby performing integrated control of the recording unit 12 (printer engine 12a) and other pieces of hardware constituting the network multifunction peripheral 1.

The control unit 11 includes the printer controller 11a that expands the print data (such as PDL data), received from the external PC 30 connected through the LAN 51, into raster data. The printer controller 11a executes a language processing program to expand the print data into the raster data. The raster data expanded by the printer controller 11a is outputted to the recording unit 12 (printer engine 12a) through the control unit 11.

The recording unit 12 is an electrophotographic printer that prints out the raster data inputted from the control unit 11 onto the sheet. The recording unit 12 prints out onto the sheet the image data scanned and produced by the scanning unit 15 and the image data received by the FAX or the IFAX. Therefore, the recording unit 12 includes the printer engine 12a and the cooling fan 12b.

As described above, when the reply to the connection confirmation signal has not been successively received for the second predetermined time (for example, 5 seconds) after the connection confirmation signal is sent, the supplies of the power to the control unit 11 and the recording unit 12 are stopped and the control unit 11 and the recording unit 12 become the low-power consumption state. When the print processing has not successively performed for a predetermined time or more, the supplies of the power to the control unit 11 and the recording unit 12 are also stopped, and the control unit 11 and the recording unit 12 become the low-power consumption state. On the other hand, the supplies of the power to the control unit 11 and the recording unit 12 are started in response to a start-up signal and the control unit 11 and the recording unit 12 become the normal power state.

The printer engine 12a is a printing mechanism that performs the printout. The printer engine 12a is controlled by the control unit 11, and the printer engine 12a prints out onto the sheet the raster data inputted from the control unit 11. More specifically, the printer engine 12a prints out the raster data by performing printing processes such as paper feeding, charging of a drum, laser irradiation, toner application, and transferring and fixing of an image to a sheet.

When the processing of receiving the print data transmitted from the PC 30 is normally ended, the NIC 10 notifies the printer controller 11a constituting the control unit 11 of the information indicating the end of the reception. At the time the expanding processing (rasterizing processing) is ended, the printer controller 11a notifies the control unit 11 of information indicating the end of the expanding processing, and then the printer controller 11a transitions to the low-power consumption state. At the time the printout performed by the printer engine 12a is ended, the control unit 11 that receives the notification notifies the NIC 10 of the information indicating the end of the printout, and then the printer engine 12a transitions to the low-power consumption state. At the time the printout is ended, the printer engine 12a transitions to the low-power consumption state.

The operation unit 13 includes a plurality of keys, such as a numeric keypad, an abbreviated key, a start key, a stop key, and various function keys, which are used to utilize each function of the network multifunction peripheral 1. The display unit 14 is a display device in which an LCD or the like is used, and the display unit 14 displays operating state of the network multifunction peripheral 1 and/or various setting contents. The scanning unit 15 includes a light source and a CCD. The scanning unit 15 scans each line of the document such as a paper document according to sub-scanning line density to produce the image data.

The codec 16 compression-codes the image data scanned by the scanning unit 15 and decodes compression-coded image data. The image storage unit 17 includes DRAM, and the image data compression-coded by the codec 16, the image data received by the FAX, and the image data received from the external PC 30 and compression-coded are stored in the image storage unit 17.

The modem (modulator/demodulator) 18 performs modulation/demodulation between the digital signal and the analog signal. The modem 18 generates and detects various pieces of functional information such as a Digital Command Signal (DCS). The Network Control Unit (NCU) 19 is connected to the modem 18 to control the connection between the modem 18 and a Public Switched Telephone Network (PSTN) 50. The NCU 19 includes a function of sending a calling signal corresponding to a facsimile number of a destination and a function of detecting the incoming calling signal.

The IFAX control unit 20 controls the IFAX function in which the Internet environment is utilized. The IFAX control unit 20 has a function of transmitting the electronic mail according to a Simple Mail Transfer Protocol (SMTP) and a function of receiving the electronic mail according to a Post Office Protocol (POP). The IFAX control unit 20 attaches to the electronic mail the transmitted document as the image data in a TIFF format or the like and transmits the electronic mail to a mail address (SMTP server). The IFAX control unit 20 receives the electronic mail from the POP server in each setting time and prints out the attached file. The Web server 21 enables the PC 30 to access pieces of data such as a home page described in HTML, a login page, and a facsimile manipulating page to perform a predetermined HTTP task.

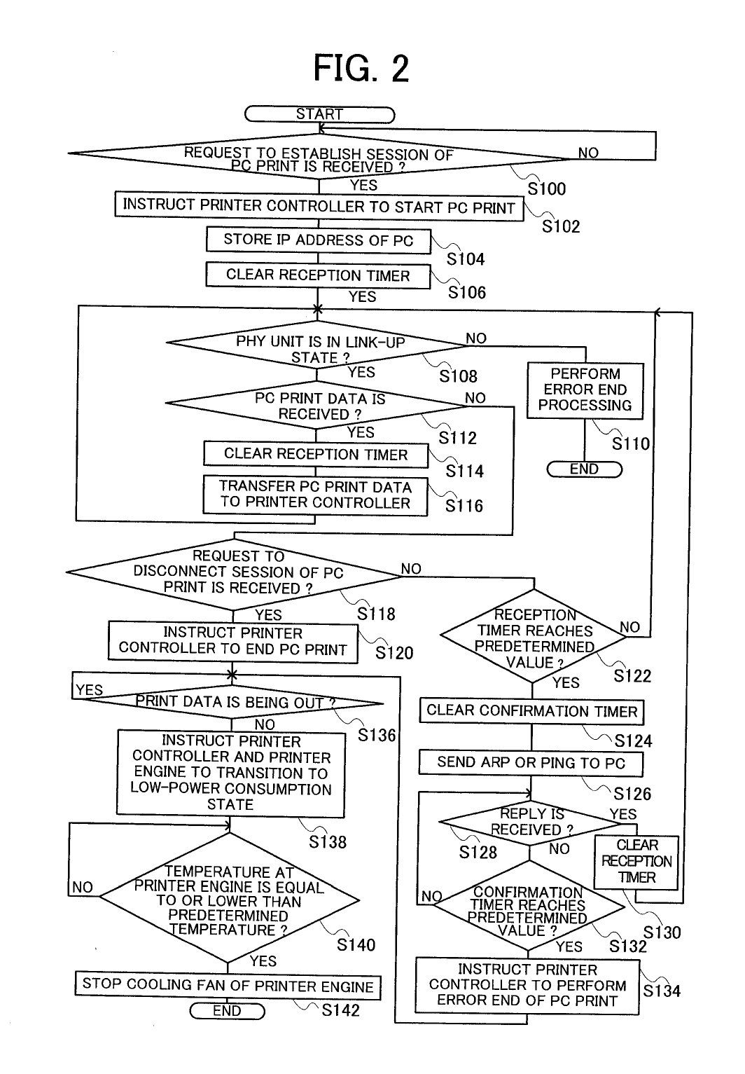

Then the low-power consumption state transition processing performed by the network multifunction peripheral 1 will be described with reference to FIG. 2. FIG. 2 is a flowchart illustrating a processing procedure of the low-power consumption state transition processing performed by the network multifunction peripheral 1.

A determination is made as to whether a request (SYN signal) to establish a session of PC print is received in step S100. When the session establishment request is not received, the processing in step S100 is repeatedly performed until the session establishment request is received. On the other hand, when the session establishment request is received, the processing proceeds to step S102.

In step S102, the session is established with the other party (in the embodiment, the PC 30) that makes the request to establish the session, and an instruction to start the PC print is provided to the printer controller 11a. In step S104, the session establishment request (SYN signal) is analyzed to extract an IP address (or MAC address) of the PC 30, and the extracted IP address of the PC 30 is stored in the RAM.

In step S106, when the print data is not received from the PC 30, a reception timer, that measures the elapsed time since the print data cannot be received, is cleared (for example, the reception timer is set to zero).

A determination is made as to whether the PHY unit 100a constituting the transmission and reception unit 100 is in the link-up state in step S108. When the PHY unit 100a is in the link-up state, the processing proceeds to step S112. On the other hand, when the PHY unit 100a is not in the link-up state, that is, when linkdown is generated, a determination is made that the abnormal network connection is generated, and the processing proceeds to step S110. In step S110, error processing, that is, when the session with the PC 30 is released, the processing of causing the control unit 11 and the recording unit 12 to transition to the low-power consumption state is performed. Then the processing is at once ended.

When the PHY unit 100a is in the link-up state, a determination is made as to whether the print data is received from the PC 30 in step S112. When the print data is received, the reception timer is cleared (step S114), and the received print data is transferred to the printer controller 11a (step S116). Then the processing proceeds to step S108, and the acts of processing in steps S108 to S116 are repeatedly performed while the print data is being received.

On the other hand, upon determination that the print data is not received in step S112, a determination is made as to whether a session disconnection request (FIN signal) is received in step S118. When the session disconnection request is received, an instruction to end the PC print is provided to the printer controller 11a in step S120. Then the processing proceeds to step S136. On the other hand, a determination is made as to whether the reception timer reaches a predetermined value, that is, a determination is made whether the print data is not successively received from the PC 30 for the first predetermined time (for example, 3 seconds) in step S122 when the reception of the print data is interrupted even the session disconnection request is not received. When the reception timer does not reach the predetermined value, that is, when the first predetermined time does not elapse since the reception is interrupted, the processing proceeds to step S108 and the acts of processing in steps S108 to S122 are repeatedly performed until the first predetermined time elapses. On the other hand, when the reception timer reaches the predetermined value, that is, when the first predetermined time elapses since the reception is interrupted, the processing proceeds to step S124.

A confirmation timer, that measures the elapsed time since a connection confirmation signal (ARP or ping) is sent to the PC 30, is cleared (for example, the confirmation timer is set to zero) in step S124. In step S126, the connection confirmation signal (ARP or ping) is sent to the PC 30.

A determination is made as to whether a reply to the connection confirmation signal sent in step S126 is received from the PC 30 in step S128. When the reply is received from the PC 30, a determination is made that the possibility of automatically restoring the network connection in a relatively short time is high because the network is normally connected. After the reception timer is cleared in step S130, the processing proceeds to step S108. Then the acts of processing from step S108 are performed again. On the other hand, when the reply is not received from the PC 30, the processing proceeds to step S132.

A determination is made as to whether the confirmation timer reaches the predetermined value, that is, a determination is made as to whether the reply to the connection confirmation signal has not been successively received for the second predetermined time (for example, 5 seconds) in step S132. When the confirmation timer does not reach the predetermined value, that is, when the second predetermined time does not elapse since the connection confirmation signal is sent, the processing proceeds to step S128, and the acts of processing in step S128 and S132 are repeatedly performed until the second predetermined time elapses. On the other hand, when the confirmation timer reaches the predetermined value, that is, when the second predetermined time elapses since the connection confirmation signal is sent, a determination is made that the possibility of automatically restoring the network connection in a short time is low due to the abnormal network. Then the processing proceeds to step S134.

In step S134, an instruction to perform error end of the PC print is provided to the printer controller 11a. Then the processing proceeds to step S136. A determination is made as to whether the print data is being printed out in step S136. When the print data is being printed out, the processing in step S136 is repeatedly performed until the printout is ended. On the other hand, when the printout is ended, the processing proceeds to step S138.

In step S138, a transition signal is outputted in order to cause the control unit 11 (printer controller 11a) and the recording unit 12 (printer engine 12a) to transition from the normal power state to the low-power consumption state. Therefore, the control unit 11 and the recording unit 12 transition to the low-power consumption state.

A determination is made as to whether a temperature at the printer engine 12a constituting the recording unit 12 is equal to or lower than a predetermined temperature in step S140. When the temperature at the printer engine 12a is higher than the predetermined temperature, the processing in step S140 is repeatedly performed until the temperature at the printer engine 12a becomes the predetermined temperature or less. Meanwhile, the cooling fan 12b is driven to cool the printer engine 12a. On the other hand, when the temperature at the printer engine 12a is equal to or lower than the predetermined temperature, the processing proceeds to step S142. The cooling fan 12b of the recording unit 12 is stopped in step 142, and the processing is ended.

According to the embodiment, for example, when the first predetermined time is set to about 3 seconds and the second predetermined time is set to about 5 seconds, the connection confirmation signal is sent in early timing after the communication is interrupted, and the determination can rapidly be made as to whether the possibility of automatically restoring the interruption of the print data in a short time is high by detecting the presence or absence of the reply to the connection confirmation signal. When the reply is not received, that is, when the determination is made that the possibility of automatically restoring from the interruption of the print data in a short time is low due to the generation of the abnormal connection of the LAN 51, the control unit 11 and the recording unit 12 can rapidly transition to the low-power consumption state without awaiting the reply longer. Therefore, when the print data is not received, the control unit 11 and the recording unit 12 can properly and rapidly transition to the low-power consumption state in response to the cause of the communication interruption.

According to the embodiment, the connection confirmation signal is sent, only when the PHY unit 100a constituting the transmission and reception unit 100 is in the link-up state, that is, only when the network connection to the closest hub or router is physically normal. In the network printer of the embodiment, when the linkdown of the PHY unit 100a is generated, that is, when the abnormal network connection to the closest hub or router is generated, the connection confirmation signal is not sent after the first predetermined time, and the control unit 11 and the recording unit 12 do not transition to the low-power consumption state after the second predetermined time. Therefore, in the network printer according to the embodiment, the control unit 11 and the recording unit 12 can immediately transition to the low-power consumption state at the time the linkdown is generated.

According to the embodiment, when the reply to the connection confirmation signal is received once, that is, when the abnormal connection of the LAN 51 is not generated, the connection confirmation signal is sent while a time interval is lengthened during the communication interruption from the second time. Therefore, the increase of the unnecessary processing load on the PC 30 can be reduced.

According to the embodiment, the ARP or the ping is used as the connection confirmation signal, so that the abnormal connection to the communication terminal, that is, the abnormal network can be detected without use of the dedicated communication protocol. Therefore, versatility can be enhanced.

According to the embodiment, the temperature control unit 102 constituting the NIC 10 performs the temperature control until the temperature at the recording unit 12 (printer engine 12a) becomes the predetermined temperature or less. Therefore, the control unit 11 can rapidly transition to the low-power consumption state.

Thus, the embodiment of the present invention is described above. The present invention is not limited to the embodiment, but various modifications can be made in the present invention. For example, in the configuration of the embodiment, the control unit 11 and the recording unit 12 take two states, that is, the low-power consumption state and the normal power state. Alternatively, the control unit 11 and the recording unit 12 may take at least three power states. For example, the control unit 11 and the recording unit 12 may further take a standby state (standby mode) as an intermediate state.

In the configuration of the embodiment, when the control unit 11 and the recording unit 12 are in the low-power consumption state, the power is supplied to the whole NIC 10. However, the present invention is not limited to the configuration of the embodiment. For example, in the NIC including a plurality of portions, when the control unit 11 and the recording unit 12 are in the low-power consumption state, the power may be supplied to only a part of the portions while the supplies of the power to other portions are stopped.

In the embodiment, the PC is used as the communication terminal by way of example. However, the communication terminal is not limited to the PC. For example, the communication terminal may be a network multifunction peripheral. Further, the communication protocol used is not limited to the communication protocol of the embodiment.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A network printer comprising:
a communication unit that conducts communication with a communication terminal connected through a network; and
a recording unit having a first power state and a second power state, power consumption of the second power state being lower than that of the first power state, the recording unit recording print data received from the communication unit onto a sheet when being in the first power state, wherein
the communication unit includes:
a confirmation signal delivery unit that sends a connection confirmation signal to the communication terminal when the print data is not successively received from the communication terminal for a first predetermined time while a session is established; and
a transition unit that causes the power state of the recording unit to transition to the second power state when a reply to the connection confirmation signal is not successively received for a second predetermined time after the confirmation signal delivery unit sends the connection confirmation signal.

2. The network printer according to claim 1, wherein
the recording unit includes:
a printer controller that expands the print data described in a page description language into raster data;
a printer engine that records the raster data onto the sheet; and
a control unit that controls the printer engine, and
the communication unit aborts processing of conducting communication with the communication terminal and the transition unit causes the respective power state of the printer controller, the printer engine, and the control unit to transition to the second power state, when a reply to the connection confirmation signal is not successively received for the second predetermined time.

3. The network printer according to claim 1, wherein
the communication unit includes a PHY unit that performs conversion between a logic signal and an electric signal, and
the confirmation signal delivery unit sends the connection confirmation signal when the PHY unit is in a link-up state.

4. The network printer according to claim 3, wherein
a session with the communication terminal is released and the transition unit causes the power state of the recording unit to transition to the second power state, when the PHY unit is not in the link-up state.

5. The network printer according to claim 1, wherein
the confirmation signal delivery unit sends the connection confirmation signal to the communication terminal, when a reply to the connection confirmation signal is received before the second predetermined time elapses since the connection confirmation signal is sent, and when the print data is not successively received for a time longer than the first predetermined time.

6. The network printer according to claim 1, wherein
the connection confirmation signal is an ARP or a ping.

7. The network printer according to claim 2, wherein
the communication unit notifies the printer controller of information indicating an end of reception when processing of receiving the print data transmitted from the communication terminal is normally ended,
the printer controller notifies the control unit of information indicating an end of the expanding processing and transitions to the second power state when the expansion of the print data is ended, and
the control unit notifies the communication unit of information indicating an end of the recording processing and transitions to the second power state when the printer engine ends the recording of the print data.

8. The network printer according to claim 1, wherein
the communication unit further includes a temperature control unit that performs temperature control such that a temperature at the recording unit becomes a predetermined temperature or less after the power state of the recording unit transitions to the second power state.

9. The network printer according to claim 1, wherein
when the communication unit receives the print data from the communication terminal, after a session is established with the communication terminal, a session establishment request received from the communication terminal is analyzed and an IP address or a MAC address of the communication terminal is extracted.
